(19) United States
(12) Patent Application Publication
(10) Pub. No.: US 2010/0006695 A1
(43) Pub. Date: Jan. 14, 2010

(54) VERTICAL TAKE-OFF AND LANDING VEHICLE WHICH DOES NOT HAVE A ROTARY WING

(76) Inventor: Michel Aguilar, Castanet Tolosan (FR)

Correspondence Address: YOUNG & THOMPSON, 209 Madison Street, Suite 500, Alexandria, VA, 22314, US

(21) Appl. No.: 12/442,778

(22) PCT Filed: Sep. 10, 2007
(86) PCT No.: PCT/FR07/01452

§ 371 Date: Mar. 25, 2009

(30) Foreign Application Priority Data
Sep. 25, 2006 (FR) 0608353
Dec. 18, 2006 (FR) 0611002

(51) Int. Cl. B64C 29/00; B64D 25/12

(52) U.S. Cl. 244/12.5; 244/140

(57) ABSTRACT

A vertical take-off vehicle includes two thermoreactors/turbine engines having a rectangular air inlet opening into a positive-displacement rotary compressor supplying compressed air to a tank connected to (i) a combustion chamber whose exhaust gases actuate a compressor-driving turbine and discharge onto the fixed rear wing upper surface, and (ii) the combustion chamber of the main engine whose exhaust gases discharge directly onto the wing upper surface, the variable incidence of which, in take-off mode, generates a lift force adding to the forces that develop on the front wings. In take-off mode, the variable-geometry upper surfaces of the front wings have a maximum camber onto which the exhaust gases produced in an internal combustion chamber flow at great speed. In cruise mode, the combustion chamber is off and the upper surface returns to a reduced camber position as the rear wing returns to an incidence optimizing total drag and lift forces.

This invention relates to a vertical take-off and landing vehicle without rotary wings.

Up to now, only vehicles with rotary wings (helicopters), aircraft with tilting propulsion wings, called convertibles, and jet aircraft having at least one downward steerable jet nozzle allow for vertical take-off and landing, as well as for hovering (lift). Horizontal displacement is ensured by a slight forward inclination of the main rotor for helicopters, a forward rotation by about 90 degrees of the whole wing/propulsive force unit for convertibles, and an almost horizontal orientation of the jet nozzle for jet airplanes.

The inventive vehicle can do without such mechanically complex movements of rotation and orientation in order to ensure vertical take-off and landing. It is based on the following findings:

the turbine engine (jet engine) used for generating the propulsive force of the aircraft sucks air into an air intake manifold, compresses the air, mixes it with fuel (kerosene . . . ), causes combustion thereof, then discharges the exhaust gas backwards at high speed and high temperature through a jet nozzle,

the propulsive force being the product of mass flow (almost the number of kilograms of air sucked in per second) times the difference of gas input/output speeds.

Therefore, by positioning adequate wings (variable geometry, incidence, and profile, thickness, materials . . . ) at the air inlet of the compressor of the turbine engine and at the jet nozzle output so that such wings only expose their upper surfaces to the input/output flows of the turbine engine, a lift force develops thereby ensuring vertical take-off and landing.

The turbine engine according to the invention is characterized by the engine thereof, hereafter called thermoreactor, one of the features of which is to generate compressor input/jet nozzle output flows of rectangular cross-sections adapted to blowing on the upper surface of the above-mentioned wings.

Up to now, turbine engines creating a propulsive force are mainly classified as follows:

1 Turbojets: they take an air mass from the atmosphere, compress it by means of a centrifugal or axial compressor, mix it with fuel (kerosene, . . . ), combust it in a combustion chamber, then direct such exhaust gases to a turbine designed to change part of the thermal energy into mechanical rotational energy in order to drive the compressor, thus making the turbine engine self-contained. The exhaust gases are then discharged at high speed into the atmosphere through a jet nozzle, thereby producing the propulsive force.

2 Ramjets: as they have a very simple mechanical arrangement (no mechanical compressor or turbine), they allow for very high displacement rates to be obtained, but require beforehand a great initial forward speed so that air compression can take place by a “simple” aerodynamic effect in the air inlet thereof.

3 Pulse jets: mainly used during the last war by the Germans in conjunction with the famous V1, operating in pulsed mode.

The thermoreactor according to the invention cumulates the advantages of these three propulsion modes in that a rotary positive-displacement compressor with vanes, lobes (Roots) or the like, the air inlet of which has a rectangular cross-section, sucks in an air mass taken from the atmosphere in order to compress it, and then direct it towards a so-called transit tank. Various ducts start from this tank, supplying:

1 the turbojet: via a combustion chamber open onto an impulse (or reaction) turbine, designed to convert part of the heat energy produced in the combustion chamber into mechanical rotational energy required for driving the compressor. The turbojet is thus made self-containing. The remaining heat energy is then changed into kinetic energy. The exhaust gases are then accelerated via an adequate jet nozzle and only blow over the upper surface of a wing positioned accordingly.

2 the ramjet: via another combustion chamber, the heat energy of the high energy exhaust gases is completely converted into kinetic energy, and said gases are then directly (plus turbine) directed by an adequate jet nozzle and discharged at high speed, thereby producing the desired propulsive force.

In addition, each of the ducts connecting the tank to the combustion chamber is fitted with a valve designed to optimally control the different air flows adapted to the operating phases of the thermoreactor.

Depending on the different phases of take-off, landing, or cruising, the front and rear wings will have the following features:

1 At take-off

Front wing: In order to create lift on this wing, exhaust gases produced in a combustion chamber and the associated jet nozzle having rectangular cross-sections, housed in the very interior of this front wing, will flow at a consistent rate only on the variable geometry upper surface, which then has an optimal curvature during the take-off phase. The exhaust gases will then flow to the outside through an opening made under the main air inlet of the compressor.

Rear wing:

a) The exhaust gases of the turbojet, discharged at high speed from the combustion chamber and the jet nozzle thereof, having rectangular cross-sections, after having yielded part of their energy to the turbine in order to drive the compressor, will flow only on the upper surface having a fixed camber profile, thereby generating additional lift.

b) High energy exhaust gases discharged from the rectangular cross-section combustion chamber of the main engine (ramjet), will flow only on the supper surface of a wing the variable incidence of which is set so as to generate maximum lift during take-off phase.

2 Cruising

In forward flight, main lift is quickly ensured by the fuselage and associated cabin designed around a wing profile; this lift is complemented by those of the 2 fixed rear wings and of the variable incidence wing set so as to minimize drag thereof:

Front wing: as lift developed on this wing is no longer justified—the combustion chamber being now switched off—the upper surface thereof is returned to a camber such that drag forces are minimal.

Rear wing: in forward flight, this wing is returned to an incidence, which is then comprised in the overall extension of the thermoreactor so as to exhibit only minimal drag, while generating just the required lift.

Two scoops are made on the upper surface and the lower surface of the power plant in order to maintain an acceptable temperature on the rear wings permanently exposed to the flow of very hot gases discharged from the main engine (ramjet) and the turbojets activating the turbines. This fresh air flow will participate just as much in reducing noise pollution.

In case of serious damages, the cabin can detach from the vehicle and continue to drop hanging from a parachute; before the final impact, this security device is completed by the deployment of airbags under the cabin in order to guarantee maximum protection of the passengers.

The tank and the batteries are movable so as to constantly adjust the overall center of gravity exactly opposite the resultant of the lift forces.

During all phases of take-off, cruise and landing, the vehicle will be piloted primarily by satellite and/or any other terrestrial means.

The fuel used will preferably be a so-called renewable energy like biofuel (sunflower seed oil, rapeseed oil . . . ).

The invention is illustrated in the drawings attached:

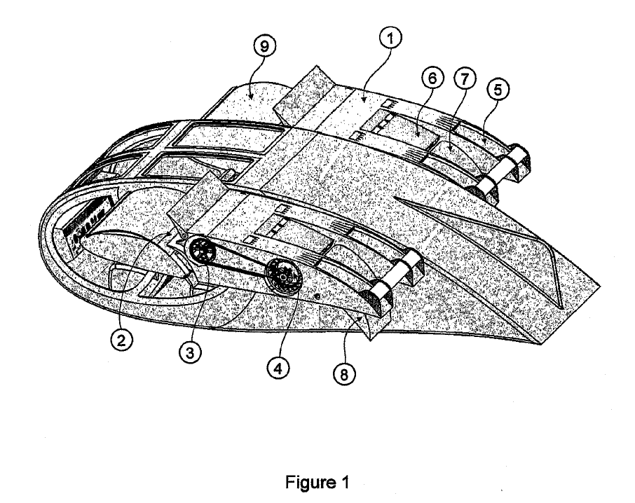

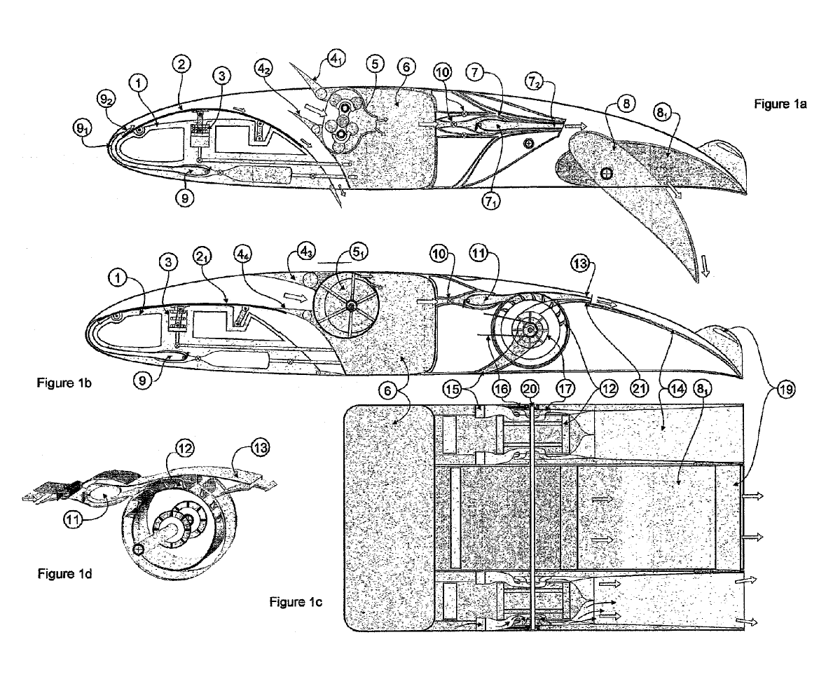

FIG. 1a represents in a longitudinal sectional view the power plant hereafter called thermoreactor, with the front wing (1) and variable geometry upper surface (2), the camber of which—being shown at a maximum in order to ensure the desired lift during take-off phase—is actuated by the mechanism (3), the combustion chamber (9) and the associated jet nozzle (9₁) for discharging exhaust gases (9₂). The aspiration inlet of the rotary positive-displacement compressor (5) having Roots type lobes or vanes (5₁), FIG. 1b—the tips (4₁) and (4₂) of which are in the “take-off” position—supplying the tank (6) with compressed air, communicates with the combustion chamber (7₁) of the main engine (7) the exhaust gases of which, upon leaving the jet nozzle (7₂) thereof blow onto the upper surface of the rear wing (8) positioned in “take-off” mode or (8₁) in “cruise” mode.

FIG. 1b represents the upper surface (2) of the front wing (1) in cruise mode, the camber thereof being returned by the mechanism (3) to a profile offering minimum drag; the combustion chamber (9) being switched off beforehand. The air inlet tips (4₃) and 4₄) being positioned in “cruise” mode. Via the control valve (10), the compressed air tank (6) is made to communicate with the combustion chamber (11) the exhaust gases of which activate the turbine (12), and are then discharged through the jet nozzle (13) only on the upper surface of the wing (14).

FIG. 1c shows the overall rear part of the thermoreactor and the associated tank (6) in plan view with the two assemblies thereof: combustion chamber (11), turbine (12), and associated jet nozzle (13). The fan (17) mounted on the rotational axis (20) of the turbines (12) mounted symmetrically is supplied with external fresh air by the inlet (15), and is sandwiched via the duct (21) between the very hot exhaust gases at the jet nozzle output (13) and the upper surface (14), on which the gases are flowing. The pulley (16) mounted on the axis (20) and the associated belt (or any other mechanism) drive the compressor. The flap (19) connects the two above-mentioned assemblies with each other.

FIG. 1d represents the turbojet seen from the combustion chamber (11) thereof, opening onto the turbine (12), and the exhaust gases of which are discharged via the jet nozzle (13).

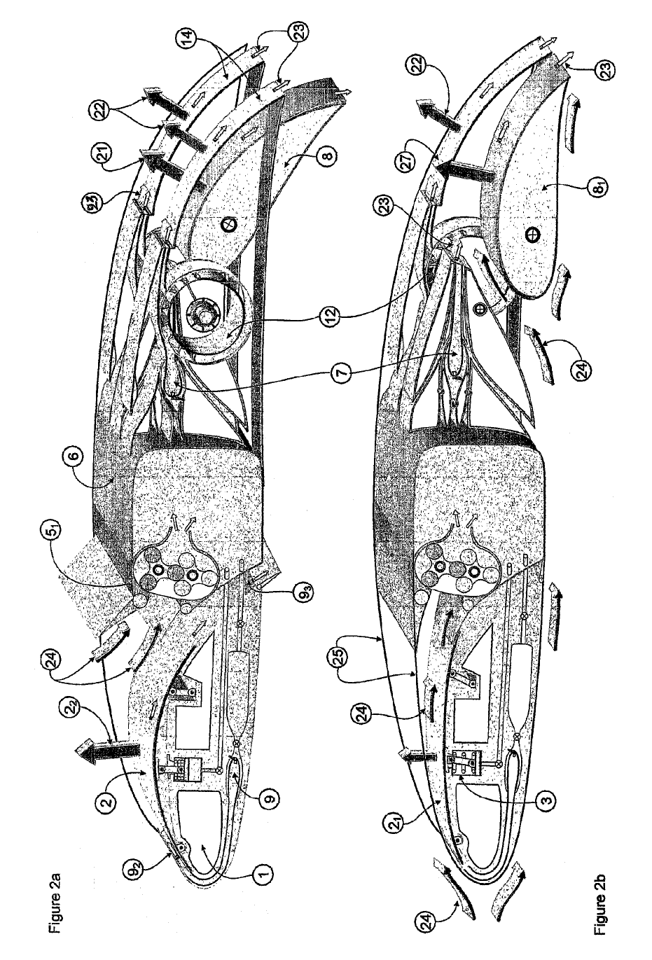

FIG. 2a represents the thermoreactor in a perspective view in the take-off configuration thereof, with the upper surface (2) of the front wing (1) having a maximum camber in order for lift (2₁) to develop under the effect of the flow of exhaust gases (9₂) flowing on said camber and escaping through the jet nozzle (9₃).

External fresh air (24) is sucked in via the air inlet of the compressor (5₁), then stored in the tank (6) in order to supply the main engine (7) and for lift (21) to develop through blowing of exhaust gases only on the upper surface of the rear wing (8) shown in take-off position. Upon leaving the turbine (12)—and symmetrically—the exhaust gases (23) flow only on the upper surfaces (14) to produce lift (22).

FIG. 2b represents the thermoreactor in a perspective view in the cruise configuration thereof, with the upper surface (2) of the front wing (1) here having a minimum camber under the effect of the mechanism (3), the external fresh air (24) then bypassing said wing while still being guided laterally on the upper surface thereof by the flanges (25) to the air inlet (4) of the compressor (5₁); the rear wing (8₁) then returning to an incidence adapted to the cruise configuration, but still exposed on the upper surface thereof to the flow of exhaust gases (23) emitted by the main engine (7), and receiving on the lower surface thereof during forward flight the external air flow (24), thus developing lift (27).

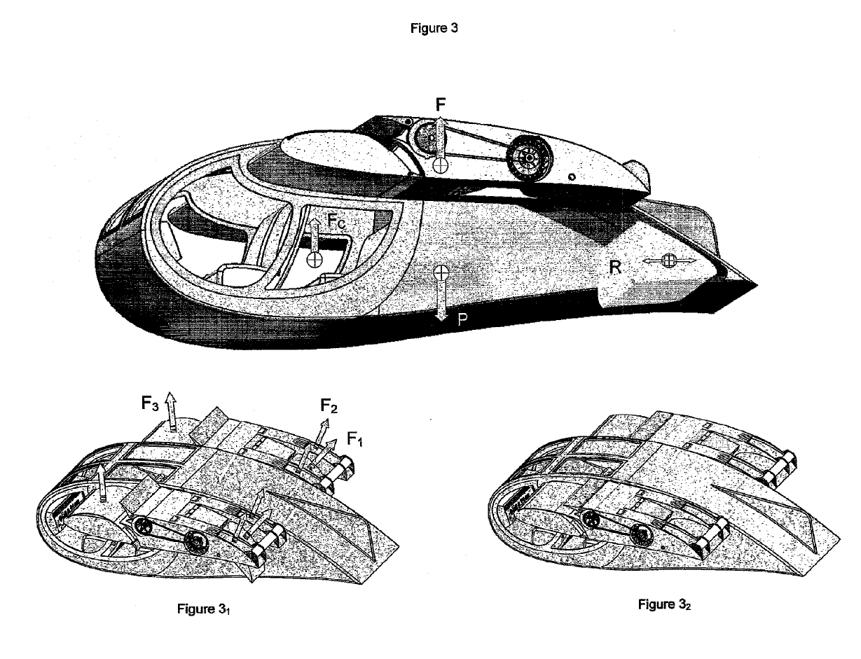

FIG. 3 represents a possible construction of this vertical take-off vehicle, both thermoreactors thereof being positioned symmetrically with respect to the fuselage/cabin assembly having a capacity of four passengers. The lift force F_{c} generated by this assembly amounts to nearly ⅔ of the overall lift.

FIG. 3₁ represents the vehicle in “take-off” mode, and the lift values F₁, F₂, F₃ developed by the front and rear wings (fixed and variable);

FIG. 3₂ represents this vehicle in “cruise” mode.

The fuel tank R and the battery housed in the fuselage can be moved in order to constantly maintain the static or dynamic balance of the vehicle.

1. A vertical take-off and landing vehicle without rotary wings, characterized in that each of the turbine engines thereof, hereafter called thermoreactor, is composed of a centrifugal or equivalent rotary positive-displacement lobe compressor (5) with vanes (5₁), the rectangular air inlet (4) of which supplies with compressed air a tank (6) connected on the one hand to two symmetrical combustion chambers (11), the exhaust gases of which actuate two symmetrical reaction turbines (12) driving the compressor (5₁), are then discharged by the jet nozzle (13) having a rectangular cross-section only on the upper surface (14) of the rear wing, thereby creating lift, and connected on the other hand to a combustion chamber (7₁) of the main engine (7) having a rectangular cross-section the exhaust gases (7₂) of which are directly directed on the upper surface of the wing (8), the incidence of which is in take-off mode set so as to generate lift, then in cruise mode is returned to (8₁) so as to generate optimal lift and drag forces.

2. The vehicle according to claim 1, characterized in that in take-off mode, under the effect of the compressed-air return spring or equivalent mechanism (3), the variable geometry upper surface (2) connected to the front wing (1) through appropriate hinges, then has a maximum camber on which exhaust gases (9₂) flow, which are produced in the combustion chamber (9) of the same construction as combustion chamber (7₁), thereby creating a lift force (2₂), the gases then being discharged to the outside via the jet nozzle (9₃)—an opening made under the air inlet of the compressor—, and in cruise mode—the combustion chamber (9) being switched off—this upper surface (2₁) is returned by the mechanism (3) to a camber such that the front wing (1) has a minimum drag profile.

3. The vehicle according to claim 1, characterized in that the fuel tank and the electric battery, both housed in the fuselage, are movable so as to maintain the static and dynamic balance of the vehicle in the different flight modes thereof.

4. The vehicle according to claim 1, characterized in that the passenger cabin, in case of serious damage, can be detached from the vehicle, then, upon deployment of airbags under the floor thereof and opening of a parachute, continue to drop on the ground while preserving the passengers' physical integrity.

5. The vehicle according to claim 2, characterized in that the fuel tank and the electric battery, both housed in the fuselage, are movable so as to maintain the static and dynamic balance of the vehicle in the different flight modes thereof.

6. The vehicle according to claim 2, characterized in that the passenger cabin, in case of serious damage, can be detached from the vehicle, then, upon deployment of airbags under the floor thereof and opening of a parachute, continue to drop on the ground while preserving the passengers' physical integrity.

7. The vehicle according to claim 3, characterized in that the passenger cabin, in case of serious damage, can be detached from the vehicle, then, upon deployment of airbags under the floor thereof and opening of a parachute, continue to drop on the ground while preserving the passengers' physical integrity.
